(19) United States
(12) Patent Application Publication
(10) Pub. No.: US 2025/0239817 A1
(43) Pub. Date: Jul. 24, 2025

(54) RELIABLE WATER RESISTANT RECEPTACLE CONNECTOR

(71) Applicant: Amphenol East Asia Electronic Technology (Shenzhen) Co., Ltd., Shenzhen (CN)

(72) Inventors: Kangqin LI, Shenzhen (CN); Zhimin QIN, Shenzhen (CN)

(73) Assignee: Amphenol East Asia Electronic Technology (Shenzhen) Co., Ltd., Shenzhen (CN)

(21) Appl. No.: 19/034,332

(22) Filed: Jan. 22, 2025

(30) Foreign Application Priority Data
Jan. 24, 2024 (CN) 202420181269.3

(51) Int. Cl. H01R 13/6597; H01R 12/72; H01R 13/52; H01R 43/20

(52) U.S. Cl. CPC H01R 13/6597; H01R 12/722; H01R 13/5202; H01R 43/20

(57) ABSTRACT

A reliable water resistant receptacle connector comprising a terminal assembly including conductive elements having mating ends held by a tongue of a housing and tails extending out of a rear portion of the housing is enclosed by connected shells. The housing has portions disposed between and protruding above the tongue and the rear portion. A conductive member on the housing is connected to a shielding member in the housing. A first shell surrounds the terminal assembly from the tongue to the first portion and is connected to the conductive member. The first shell has a front outside seal and a rear inside seal. A second shell is disposed on and connected to the first shell. A third shell is disposed on and connected to a portion of the second shell disposed on the rear portion of the housing. Both the second and third shells can mount to a circuit board.

### CROSS-REFERENCE TO RELATED APPLICATIONS

This application claims priority to and the benefit of Chinese Patent Application Serial No. 202420181269.3, filed on Jan. 24, 2024, the contents of which are incorporated herein by reference in their entirety.

### TECHNICAL FIELD

This application relates to interconnection systems, such as those including electrical connectors, configured to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

A known arrangement for joining several electronic subassemblies is to have one printed circuit board serve as a backplane. A known backplane is a PCB onto which many connectors may be mounted. Conducting traces in the backplane may be electrically connected to signal conductors in the connectors such that signals may be routed between the connectors. Other printed circuit boards, called “daughterboards,” “daughtercards,” or “midboards,” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may plug into the backplane at a right angle. The connectors used for these applications may therefore include a right angle bend and are often called “right angle connectors.”

Connectors may also be used in other configurations for interconnecting electronic assemblies. Sometimes, one or more printed circuit boards may be connected to another printed circuit board, called a “motherboard,” that is both populated with electronic components and interconnects the daughterboards. In such a configuration, the printed circuit boards connected to the motherboard may be called daughterboards. The daughterboards are often smaller than the motherboard and may sometimes be aligned parallel to the motherboard. Connectors used for this configuration are often called “stacking connectors” or “mezzanine connectors.” In other systems, the daughterboards may be perpendicular to the motherboard.

Connectors may also be used in computers in which the motherboard might have a processor and a bus configured to pass data between the processor and peripherals, such as a printer or memory device. Connectors may be mounted to the motherboard and connected to the bus. A mating interface of those connectors may be exposed through an opening in the enclosure for the computer, such that connectors, often attached to the peripheral through a cable, may be inserted into the connectors on the motherboard. With this configuration, a peripheral can be easily connected to a computer.

To enhance the availability of peripherals, the bus and the connectors used to physically connect peripherals via the bus may be standardized. In this way, there may be a large number of peripherals available from a multitude of manufacturers. All of those products, so long as they are compliant with the standard, may be used in a computer that has a bus compliant with the standard. Examples of such standards include universal serial bus (USB), which is commonly used in computers. The standards have gone through multiple revisions, adapting to the higher performance expected from computers over time. For example, portable electronic devices often include USB Type-C receptacle connectors for various purposes such as charging and/or exchanging data with another electronic device by connecting the USB receptacle connector with a USB plug connector.

Some USB connectors are water resistant. These connectors may include seals that block water from outside the computer enclosure from entering the computer enclosure through the opening left for the connector.

### BRIEF SUMMARY

Aspects of the present application relate to reliable water resistant receptacle connectors.

Some embodiments relate to a receptacle connector configured for mounting to a substrate and extending in a vertical direction above the substrate. The receptacle connector may comprise: a terminal assembly comprising: a plurality of conductive elements, each of the plurality of conductive elements comprising a mating end, a tail, and an intermediate portion between the mating end and the tail, a housing comprising a tongue holding the mating ends of the plurality of conductive elements, a rear portion, and a first portion between the tongue and the rear portion, top surfaces of the tongue, rear portion, and first portion offset from each other in the vertical direction, and a shielding member held by the housing and comprising one or more projections extending out of the first portion of the housing; a conductive member disposed on the first portion of the housing of the terminal assembly, the conductive member comprising one or more openings configured for receiving the one or more projections of the shielding member; and a first shell surrounding the terminal assembly from the tongue to the first portion of the housing of the terminal assembly and connected to the conductive member at a first joining portion.

Some embodiments relate to a receptacle connector. The receptacle connector may comprise: a terminal assembly comprising a plurality of conductive elements, each of the plurality of conductive elements comprising a mating end, a tail, and an intermediate portion between the mating end and the tail, and a housing comprising a tongue holding the mating ends of the plurality of conductive elements, a rear portion, and a first portion between the tongue and the rear portion, top surfaces of the tongue, rear portion, and first portion offset from each other in a vertical direction; a conductive member disposed on the first portion of the housing of the terminal assembly; a first shell surrounding the terminal assembly from the tongue to the first portion of the housing of the terminal assembly and connected to the conductive member at a first joining portion; a second shell comprising a first portion disposed on a rear portion of the first shell and connected to the rear portion of the first shell at a second joining portion, a second portion disposed on the rear portion of the housing of the terminal assembly, and a transition portion connecting the first portion and the second portion; and a third shell comprising a horizontal portion disposed on and connected to the second portion of the second shell at a third joining portion, and first and second mounting portions disposed on opposite sides of the horizontal portion, each of the first and second mounting portions comprising a threaded hole.

Some embodiments relate to a method of manufacturing a receptacle connector. The method may comprise: providing a terminal assembly comprising a plurality of conductive elements, each of the plurality of conductive elements comprising a mating end, a tail, and an intermediate portion between the mating end and the tail, and a housing comprising a tongue holding the mating ends of the plurality of conductive elements, a rear portion, and a first portion between the tongue and the rear portion; disposing a conductive member on the first portion of the housing of the terminal assembly; inserting the terminal assembly into a shell until the conductive member abuts a rear end of the shell; welding the shell to the conductive member to form a joining portion; and after the welding, filling an adhesive for forming a sealing member in a gap between the first portion and rear portion of the housing of the terminal assembly.

Some embodiments relate to a receptacle connector. The receptacle connector may comprise a terminal assembly, a conductive member, a first shell, and a second shell. The terminal assembly may comprise a plurality of conductive elements and an assembly housing holding the plurality of conductive elements. The conductive member may be disposed to at least a portion of an outside portion of the assembly housing. The first shell may be disposed to an outside portion of the conductive member and attached to the conductive member, and the first shell enclosing at least a portion of the terminal assembly. The second shell may be attached to an outside portion of the first shell, wherein the receptacle connector may further comprise a third shell fixedly attached to an outside portion of the second shell, and the third shell may be provided with a mounting hole.

These techniques may be used alone or in any suitable combination. The foregoing summaries are provided by way of illustration and are not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a top, front perspective view of a receptacle connector, according to some embodiments;

FIG. 2 is a partially exploded perspective view of the receptacle connector of FIG. 1;

FIG. 3 is a perspective view of a first shell of the receptacle connector of FIG. 1;

FIG. 4 is a top, rear perspective view of the receptacle connector of FIG. 1, with the second shell and the third shell hidden;

FIG. 5 is a bottom perspective view of the receptacle connector of FIG. 4;

FIG. 6 is a perspective view of the receptacle connector of FIG. 1, with the third shell hidden;

FIG. 7 is a bottom perspective view of the receptacle connector of FIG. 6;

FIG. 8 is a top, rear perspective view of a second shell of the receptacle connector of FIG. 1;

FIG. 9 is a perspective view of a terminal assembly of the receptacle connector of FIG. 1;

FIG. 10 is a perspective view of a conductive member of the receptacle connector of FIG. 1;

FIG. 11 is a perspective view of the terminal assembly of FIG. 9 with the conductive member of FIG. 10 disposed thereon;

FIG. 12 is a side view of the terminal assembly with the conductive member disposed thereon of FIG. 11;

FIG. 13 is a cross-sectional view of the terminal assembly with the conductive member disposed thereon along a line marked “E-E” in FIG. 12, before disposing beams of the conductive member in grooves of the terminal assembly;

FIG. 14 is a cross-sectional view of the terminal assembly with the conductive member disposed thereon along a line marked “E-E” in FIG. 12, after disposing beams of the conductive member in grooves of the terminal assembly;

FIG. 15 is a perspective view of the receptacle connector of FIG. 1, with portions hidden and showing the terminal assembly, the conductive member, and a second sealing member;

FIG. 16 is a perspective view of the terminal assembly of FIG. 9, with portions hidden and showing two rows of conductive elements and a shielding member;

FIG. 17 is an exploded perspective view of the terminal assembly of FIG. 16; and

FIG. 18 is a side view of the receptacle connector of FIG. 1.

### DETAILED DESCRIPTION

The inventors have recognized and appreciated techniques for making reliable water resistant receptacle connectors. A receptacle connector may be integrated inside a chassis of an electronic device and configured to receive a mating component such as a plug connector to enable the electronic device to connect with other devices. The force applied to insert a mating component into an existing receptacle connector may cause various issues such as over-insertion and therefore poor or intermittent electrical contact, causing terminal assembly dislocation with respect to a shell.

Techniques described herein enable more compact receptacle connectors while maintaining/improving robustness. Such techniques are illustrated herein as applied to a USB Type-C right-angle receptacle connector. According to aspects of the present disclosure, a connector may include a terminal assembly enclosed by connected shells. The terminal assembly may include conductive elements having mating ends held by a tongue of a housing and tails extending out of a rear portion of the housing. The housing may have a first portion disposed between the tongue and the rear portion. The first portion of the housing may protrude above the tongue and the rear portion. A conductive member may be disposed on the first portion and connected to a shielding member in the housing at a first joining portion. A first shell may surround the terminal assembly from the tongue to the first portion and connected to the conductive member at a second joining portion. The first shell may have a front outside seal and a rear inside seal. A second shell may be partially disposed on and connected to the first shell. A third shell may be disposed on and connected to a portion of the second shell disposed on the rear portion of the housing. Both the second and third shells may mount to a circuit board.

In some embodiments, the third shell may comprise a mounting hole. A fastening element (e.g., screws, bolts, etc.) for securing the receptacle connector to a circuit board inside a chassis of an electronic device. The mounting holes may has threads. Such a configuration may enable a convenient and secure connection of the receptacle connector to the circuit board of the electronic device. The third shell of the receptacle connector may be connected to the electronic device in a detachable manner. This connection mode may be simple in structure, reliable in connection, and convenient in disassembly and assembly. This connection mode may improve the assembly efficiency of the receptacle connector, and substantially reduce the assembly cost. In some embodiments, the third shell may be an integral shell, which may reduce the number of parts used and thus the overall manufacturing cost.

In some embodiments, the third shell may be connected to the second shell by welding. The welding connection may be more cost-effective compared to riveting, bolt fastening, or similar techniques, and the welded workpiece is less susceptible to loosening or disconnecting. Welding is a process in which two or more materials of the same or different types are connected integrally by bonding and diffusion between atoms or molecules, resulting in a solid connection capable of withstanding high forces. Furthermore, welding can be realized manually, semi-automatically or fully automatically, and can be flexibly designed according to the application scenario. During the spot welding process, heat generated may be sufficient to bond the processed objects uniformly and continuously in a fast manner. The connection by spot welding may be fast. The processed objects may be less susceptible to deformation and the connection may be efficient. In addition, the connection by spot welding may not require consumables and can be adapted to automated welding production schemes, thereby increasing welding production efficiency.

In some embodiments, the conductive member may include stop portions. When the receptacle connector and the corresponding plug connector are mated with each other in the mating direction, the stop portion of the conductive member may be engaged into the groove of the first portion of the terminal assembly. Such a configuration may reduce the risk that the conductive member shift in the mating direction with respect to the terminal assembly. Such a configuration may reduce the risk that the first shell and/or the second shell connected to the conductive member shift in the mating direction with respect to the terminal assembly. Such a configuration may reduce the risk of misalignment or undesired shifting of the conductive member of the receptacle connector with respect to the terminal assembly due to frequent plugging and unplugging of the mating portion of the plug connector.

In some embodiments, the shielding member may be electrically connected to the conductive member. The shielding member may be electrically connected to the first shell and the second shell via the conductive member. The electromagnetic wave absorbed by the shielding member may be guided to a grounding portion of the electronic device via the conductive member, the first shell, and the second shell. Electromagnetic interference may be effectively shielded. For example, when the first row of conductive elements and the second row of conductive elements of the terminal assembly transmit high-frequency signals, the electromagnetic wave interference (EMI) and crosstalk signals generated between the first row of conductive elements and the second row of conductive elements can be inductively absorbed by the shielding member and transmitted by the shielding member through the first projection and the second projection thereof to the conductive member, then conducted to the first shell, the second shell, the grounding portion of the circuit board or the grounding portion of the electronic device.

In some embodiments, the connector may have a front sealing member and a rear sealing member, which may provide improved water resistance. The sealing members may be made from an adhesive, which may provide more flexibility in locating and shaping the sealing members. The adhesive may be disposed on the rough portion and shaped and cured on the rough portion to form the front sealing. One or more features may be used to provide mechanical integrity to the front seal. In some examples, the mating end of the first shell may have a rough portion. That portion may be processed differently from other portions of the first shell such that it has a surface roughness higher than other portions of the first shell. Different processing may result from processing steps, preferentially performed on the portion, to roughen the surface. Alternatively or additionally, different processing may result from omitting processing steps that tend to smooth other parts of the shell, such as cold rolling or plating. In some examples, a desired surface roughness for the rough portion may be obtained by using Electrical Discharge Machining (EDM). It should be appreciated that larger EDM may lead to higher roughness and better adhesion. In some examples, the rough portion may have patterns to enhance adhesion. These patterns may be visually observable and/or comprise symbols such as *, H, or X, which may be laser imprinted around the mating end of the first shell. In some examples, the rough portion may extend in the mating direction by a distance in a range of 0.1 mm to 5 mm such as in a range of 0.5 mm to 1.5 mm.

A front sealing member may be disposed on the rough portion of the mating end of the first shell such that the front sealing member can be securely attached to the main shell. In some examples, an adhesive (e.g., UV glue, silicone, epoxy glue, or underfill) may be disposed on the rough portion and shaped and cured on the rough portion to form the front sealing member. The front seal can be spaced from the second shell in the mating direction so as to extend above the second shell. Such a configuration may enable the front seal to deform in a direction perpendicular to the mating direction when the connector is pressed, in the mating direction, against a wall with an opening through which the mating face of the connector will be exposed, blocking ingress of environmental contaminants. The front sealing may also block any path between the mating ends of the first and second shells.

A rear sealing can be disposed in the first shell. The rear sealing member may be disposed in a gap between the first portion of the housing of the terminal assembly and the transition portion of the second shell. By providing the rear seal, a tight seal between the terminal assembly and the first and second shells may be achieved, further reducing the risk of water or dust entering through the socket of the receptacle connector into the electronic device.

Next, exemplary embodiments of the receptacle connector according to the present application will be described in detail with reference to the accompanying drawings. For a clear and concise description, a mating direction Y, a width direction X, and a vertical direction Z of the receptacle connector 1 may be shown in the figure. The mating direction Y, the width direction X, and the vertical direction Z may be perpendicular to one another. The mating direction Y may refer to a direction where the receptacle connector is connected with a corresponding plug connector. The width direction X may refer to a width direction of the receptacle connector. The vertical direction Z may refer to a height direction of the receptacle connector.

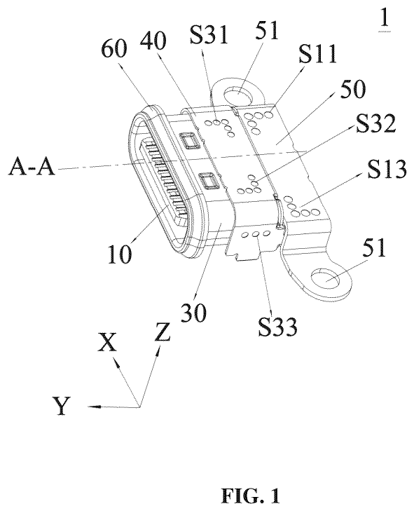

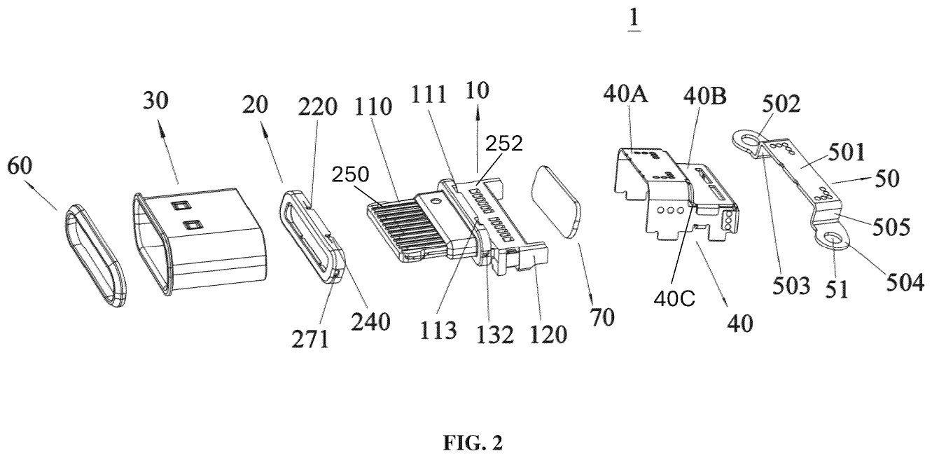

As shown in FIGS. 1-2, a receptacle connector 1 may comprise a terminal assembly 10. The terminal assembly 10 may comprise a plurality of conductive elements 110 and an assembly housing 120 holding the plurality of conductive elements 110. Optionally, the assembly housing 120 may be formed integrally with the plurality of conductive elements 110. A conductive member 20 may be disposed to at least a portion of an outside portion of the assembly housing 120. A first shell 30 may be disposed to an outside portion of the conductive member 20 and attached to the conductive member 20. The first shell 30 may enclose at least a portion of the terminal assembly 10. A second shell 40 may be attached to an outside portion of the first shell 30. The receptacle connector 1 may further comprise a third shell 50 fixedly attached to an outside portion of the second shell 40, and the third shell 50 may comprise a mounting hole 51.

The third shell 50 may comprise a horizontal portion 501 connected to the second shell 40, and first mounting portion 502 and second mounting portion 504 provided in a width direction X of the receptacle connector 1 on opposite sides of the horizontal portion 501. Each of the first mounting portion 502 and the second mounting portion 504 extends beyond the second shell 40 from the horizontal portion 501 along the width direction X. The mounting hole 51 is disposed at each of the first mounting portion 502 and the second mounting portion 504.

The horizontal portion 501 of the third shell 50 may be configured to extend in a plane perpendicular to a vertical direction Z of the receptacle connector 1. As shown in FIG. 2, the third shell 50 may comprise a first vertical portion 503 connecting the horizontal portion 501 to the first mounting portion 502, and a second vertical portion 505 connecting the horizontal portion 501 to the second mounting portion 504. Each of the first vertical portion 503 and the second vertical portion 505 may extend substantially perpendicular to the horizontal portion 501. The third shell 50 may be an integral piece.

The third shell 50 may be formed by stamping and bending a metal plate, etc. The stamping and bending process facilitates mass production of the third shell with high productivity. It should be understood that the size, shape, and arrangement mode of the third shell may not be limited to the above exemplary description, but may be provided according to the specific configuration of the receptacle connector and the respective connecting portion of the electronic device.

The third shell 50 may be connected to the second shell 40 by, for example, welding. A third joining portion may join the third shell 50 and the second shell 40. Optionally, the third shell 50 is connected to the second shell 40 by resistance welding. It should be understood that the term “resistance welding” refers to a welding process in which the heat generated by the passage of an electric current through a resistor is used to melt a metallic material and two metallic materials are connected together by pressure. Resistance welding has high heating speeds and short welding times, making it suitable for mass production. The welding joint formed by resistance welding between the third shell 50 and the second shell 40 may have high strengths, and firm and reliable connections.

Optionally, the third shell 50 is connected to the second shell 40 by spot welding. The third joining portion may comprise one or more groups of third joining points joining the third shell 50 and the second shell 40. Spot welding may utilize a column electrode to form a welding spot between two workpiece contact surfaces during welding. During the spot welding process, heat generated is sufficient to bond the processed objects uniformly and continuously in a fast manner. The connection by spot welding is fast, the processed objects are less susceptible to deformation and the connection is efficient. In addition, the connection by spot welding does not require consumables and can be adapted to automated welding production schemes, thereby increasing welding production efficiency. Optionally, the joining point may have a round shape, an oval shape or a hemispherical shape. Optionally, the joining point may have a diameter in a range between 0.2 mm and 3 mm. In some embodiments, a plurality of joining points in each group of joining points may be arranged in an equally spaced manner. For example, a spacing between neighboring joining points may be in the range between 1 mm and 5 mm. Optionally, each group of joining points may be arranged in a linear array, an L-shaped array, or a curved array.

In the illustrated example, the third joining portion comprises a first group of third joining points S11 and a second group of third joining points S13. The first group of third joining points S11 and the second group of third joining points S13 are provided to be symmetrical about an axis A-A of the receptacle connector. The horizontal portion 501 of the third shell 50 may include the first group of third joining points S11 and the second group of third joining points S13. The first group of third joining points and the second group of third joining points may be arranged symmetrically about an axis A-A of the receptacle connector. The receptacle connector 1 may be substantially symmetrical about the axis A-A. Such a configuration may reduce the stress concentration at the joining points, as well as any deformation that may be caused by the welding. Optionally, each of the first group of third joining points and the second group of third joining points may include five joining points arranged in a manner of an L-shaped array. It should be appreciated that the present disclosure is not intended to be limited by the illustrated examples. For example, the number, size, location and arrangement of each group of joining points may be configured according to specific applications.

The first shell 30 may be connected to the conductive member 20 by, for example, welding. A first joining portion may join the first shell 30 and the conductive member 20. Optionally, the first shell 30 may be connected to the conductive member 20 by spot welding. The first joining portion may comprise one or more groups of first joining points joining the first shell 30 and the conductive member 20.

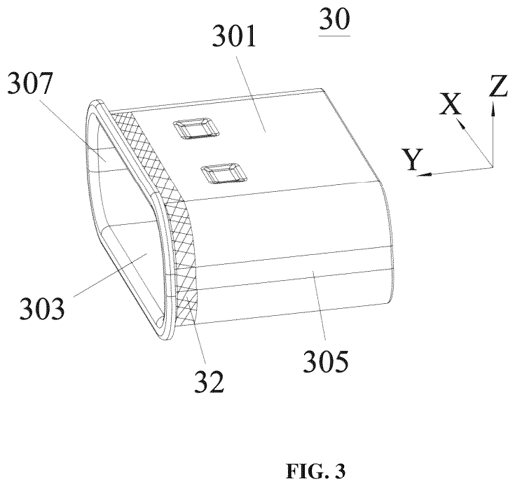

As shown in FIG. 3, the first shell 30 may have a substantially cylindrical shape. The first shell 30 may comprise a first sidewall 301 and a second sidewall 303 opposite to each other in a vertical direction Z of the receptacle connector; and a third sidewall 305 and a fourth sidewall 307 opposite to each other in a width direction X of the receptacle connector. Each of the third sidewall 305 and the fourth sidewall 307 is connected to the first sidewall 301 and the second sidewall 303.

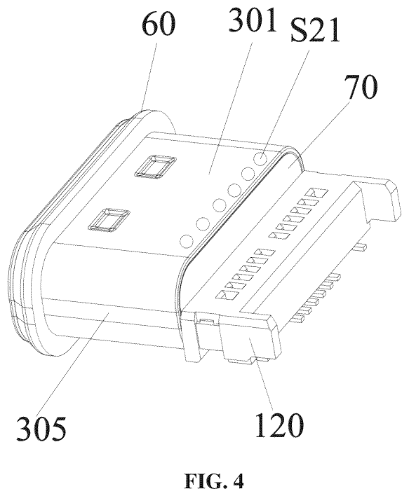

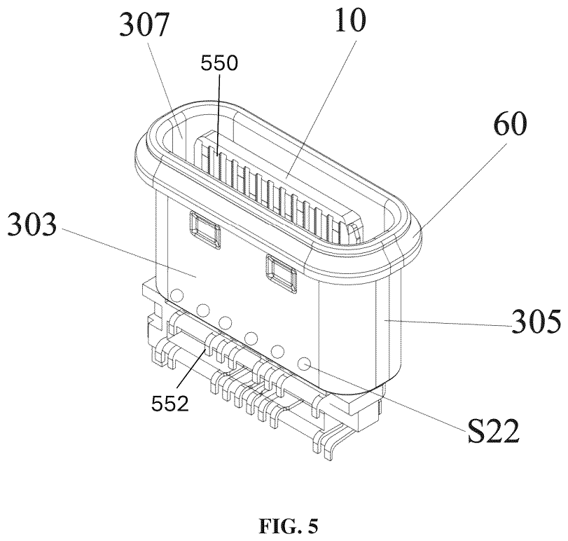

As shown in FIGS. 4-5, the first joining portion may comprise a first group of first joining points S21 and a second group of first joining points S22. The first sidewall 301 of the first shell 30 may comprise the first group of first joining points S21 adjacent to a rear end of the first shell 30. The second sidewall 303 of the first shell 30 may comprise the second group of first joining points S22 adjacent to a rear end of the first shell 30. Each of the first group of first joining points S21 and the second group of first joining points S22 may be arranged in a linear array in the width direction X of the receptacle connector.

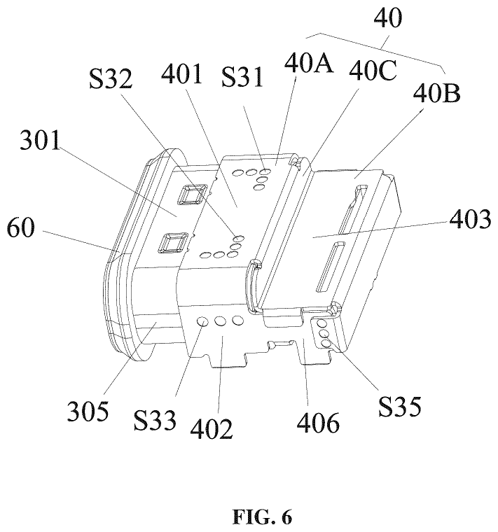

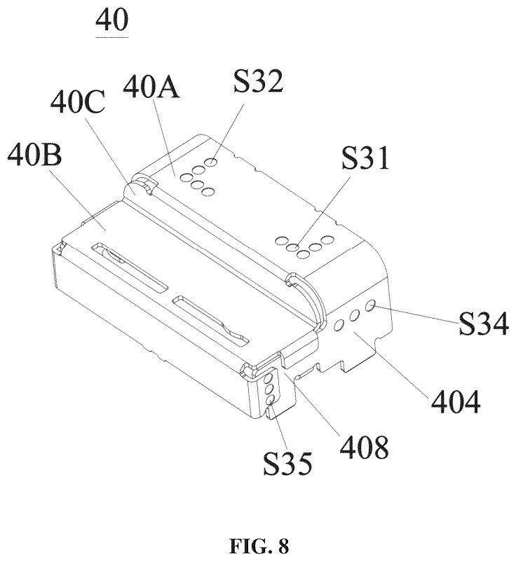

As shown in FIGS. 6-8, the second shell 40 may comprise a first portion 40A attached to the first shell 30, a second portion 40B attached to the assembly housing 120, and a transition portion 40C connecting the first portion 40A and the second portion 40B. The second portion 40B may comprise tabs 45, 47. The assembly housing 120 of the terminal assembly 10 may comprise recesses 105, 107 for receiving the tabs. The tab may be engaged with the recess for fixedly connecting the second shell 40 to the assembly housing 120. A secure connection of the second shell 40 to the assembly housing 120 of the terminal assembly 10 can be facilitated by engaging the tab with the recess, reducing the risk that the second shell 40 moves relative to the first shell 30 and the terminal assembly 10 or shifting in the mating direction Y. The structural stability and assembly efficiency of the receptacle connector may be improved. When the relative position between the second shell 40 and the first shell 30 is fixed, it may be convenient to subsequently connect the second shell 40 to the first shell 30 by welding, improving the assembly precision of the receptacle connector.

The first portion 40A of the second shell 40 may comprise a first top wall 401 connected to the first sidewall 301 of the first shell 30, a first side wall 402 connected to the first top wall 401 and substantially perpendicular to the first top wall, and a second side wall 404 opposite to the first side wall 402 in the width direction X of the receptacle connector and connected to the first top wall 401. Each of the first side wall 402 and the second side wall 404 may extend in a plane perpendicular to the width direction X of the receptacle connector 1. A bottom end of each of the first side wall 402 and the second side wall 404 may extend beyond the first shell 30 in the vertical direction Z of the receptacle connector.

The second portion 40B of the second shell 40 may comprise a second top wall 403 corresponding to an outer surface of the assembly housing 120 provided on the same side as the first sidewall 301 of the first shell 30; a third side wall 406 connected to the second top wall 403 and substantially perpendicular to the second top wall 403; and a fourth side wall 408 opposite to the third side wall 406 in a width direction X of the receptacle connector and connected to the second top wall 406. Each of the third side wall 406 and the fourth side wall 408 may extend in a plane perpendicular to the width direction X of the receptacle connector 1. A bottom end of each of the third side wall 406 and the fourth side wall 408 may extend beyond the assembly housing 120 in the vertical direction Z of the receptacle connector.

In some embodiments, the first side wall 402 and the third side wall 406 may be disposed in the same plane perpendicular to the width direction. The second side wall 404 and the fourth side wall 408 may be disposed in the same plane perpendicular to the width direction. In some embodiments, the second shell 40 may be a cover member formed by cutting, shearing, stamping, bending, and the like of a single blank and disposed over the first shell 30 and the assembly housing 120.

The tabs may comprise a first tab 45 and a second tab 47. The first tab 45 may extend from the bottom end of the third side wall 406. The first tab 45 is a sheet-like portion that is substantially perpendicular to the third side wall 406 and extends from the third side wall 406 toward the longitudinal central axis A-A of the receptacle connector. The second tab 47 may extend from the bottom end of the fourth side wall 408. The second tab 47 is a sheet-like portion that is substantially perpendicular to the fourth side wall 408 and extends from the fourth side wall 408 toward the longitudinal central axis A-A of the receptacle connector.

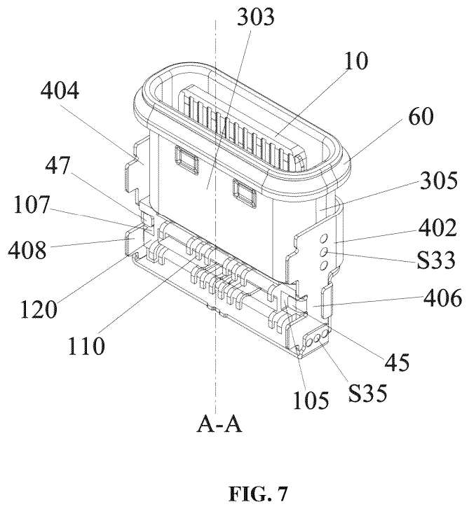

The recess may be on an outer surface of the assembly housing 120 provided on the same side as the second sidewall 303 of the first shell 30, and may be provided at an edge of the assembly housing 120 adjacent to the third side wall 406 and the fourth side wall 408. The recess may comprise a first recess 105 engaged with the first tab 45 and a second recess 107 engaged with the second tab 47. In the exemplary embodiment shown in FIG. 7, the first recess 105 and the second recess 107 may be on opposite side portions of the assembly housing 120 in the width direction X.

In some embodiments, the first portion 40A of the second shell 40 is connected to the first shell 30 by, for example, welding. A second joining portion joins the first portion 40A of the second shell 40 and the first shell 30. Optionally, the second shell 40 may be connected to the first shell 30 by resistance welding. Optionally, the first portion 40A of the second shell 40 is connected to the first shell 30 by spot welding. The second joining portion comprises a second joining point joining the first portion 40A of the second shell 40 and the first shell 30.

The second joining portion may comprise a first group of second joining points S31 and a second group of second joining points S32. The first portion 40A of the second shell 40 may be connected to the first sidewall 301 of the first shell 30 by the first group of second joining points S31 and the second group of second joining points S32. Each of the first group of second joining points S31 and the second group of second joining points S32 may be arranged in an L-shaped or linear array.

The second joining portion may further comprise a third group of second joining points S33 for connecting the first side wall 402 of the second shell 40 to the third sidewall 305 of the first shell 30, and a fourth group of second joining points S34 for connecting the second side wall 404 of the second shell 40 to the fourth sidewall 307 of the first shell 30. Each of the third group of second joining points S33 and the fourth group of second joining points S34 may be arranged in a linear array in the mating direction Y of the receptacle connector.

The second shell 40 may comprise a rear wall for at least partially surrounding a rear of the terminal assembly 10. Two edges of the rear wall in the width direction may be lapped against the third side wall 406 and the fourth side wall 408 of the second portion 40B of the second shell 40 by folding and fixedly connecting the rear wall to the third side wall 406 and the fourth side wall 408 by, for example, spot welding. The joining points S35 may join the rear wall and the third side wall 406 (or the fourth side wall 408). The spot welding process can be accomplished simultaneously during connecting the second shell 40 to the first shell 30, thereby improving the assembly efficiency of the receptacle connector.

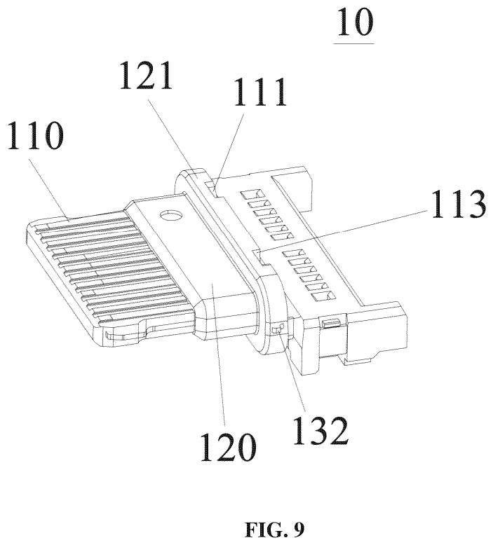

As shown in FIG. 9, the assembly housing 120 may comprise a first portion 121 connected to the conductive member 20. The first portion 121 may be disposed adjacent to a rear end of the first shell 30 and comprise a groove. The conductive member 20 may comprise a stop portion engaged with the groove. The stop portion may be formed integrally with the conductive member 20. Optionally, the conductive member 20 may comprise a plurality of stop portions provided on a top wall 23 and/or on a bottom wall 25 of the conductive member 20. The top wall 23 is opposite to the bottom wall 25 in a vertical direction Z of the receptacle connector.

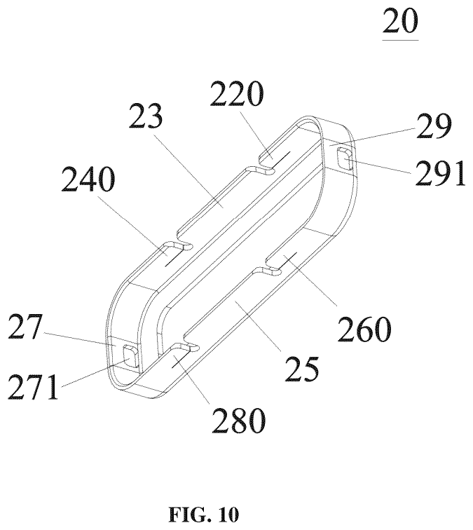

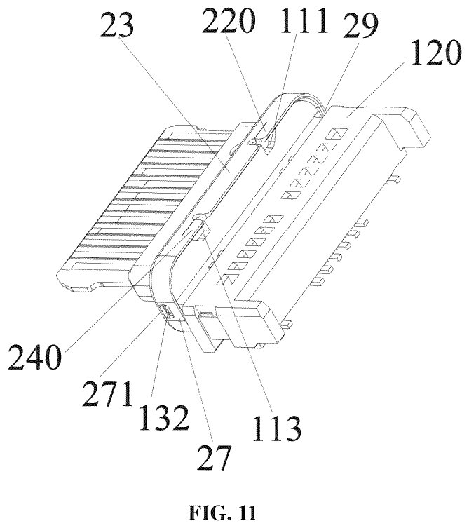

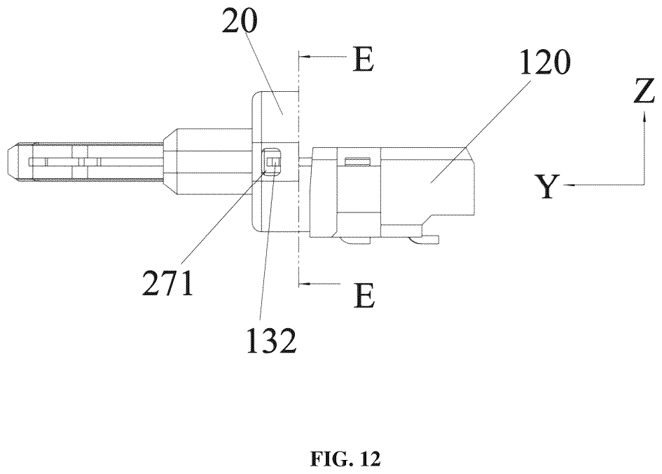

In the illustrated example of FIGS. 10-15, the stop portion may include a beam. The beam may be a sheet member cut from the annular portion of the conductive member 20. Optionally, the joint-cuttings configured to form the beam are cut from the distal edge of the conductive member 20. The beam may comprise a first beam 220 and a second beam 240 provided on the top wall 23 of the conductive member 20. The first portion 121 may comprise a first groove 111 that cooperates with the first beam 220 and a second groove 113 that cooperates with the second beam 240. The first groove 111 and the second groove 113 are open toward the conductive member 20 in a vertical direction Z of the receptacle connector.

The beam may comprise a third beam 260 and a fourth beam 280 which are provided on the bottom wall 25 of the conductive member 20. The first portion 121 may comprise a third groove 115 that cooperates with the third beam 260 and a fourth groove 117 that cooperates with the fourth beam 28. The third groove 113 and the fourth groove 117 are open toward the conductive member 20 in a vertical direction Z of the receptacle connector.

The first beam 220 and the second beam 240 extending from the top wall 23 may be arranged to be mirrored about an axis A-A of the receptacle connector 1. The third beam 260 and the fourth beam 280 extending from the bottom wall 25 are arranged to be mirrored about the axis A-A of the receptacle connector 1.

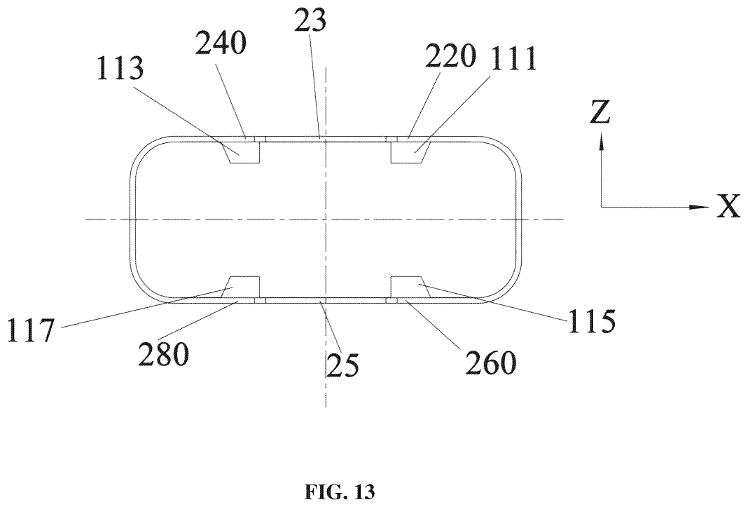

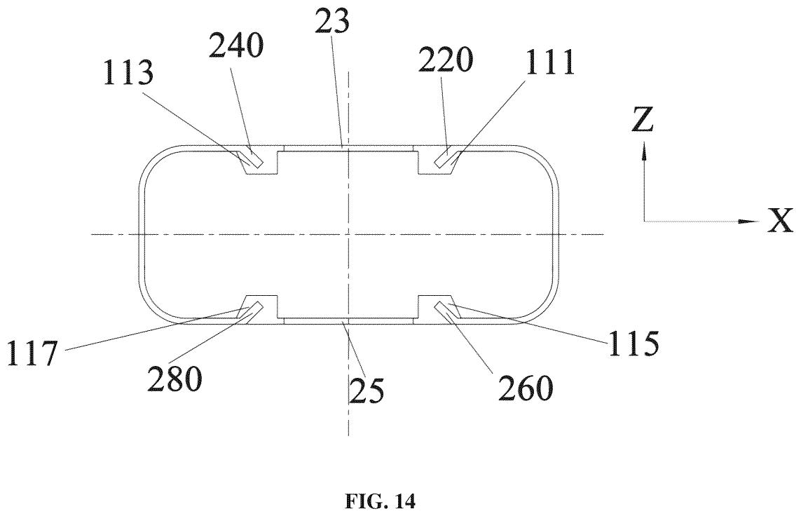

FIG. 13 illustrates a view of the respective beams of the conductive member 20 which are shown before they are bent. FIG. 14 illustrates a view of the respective beams of the conductive member 20, which are bent and inserted into a corresponding groove. As shown in FIG. 14, when the conductive member 20 is assembled with the first portion 121, the first free end of the first beam 220 and the second free end of the second beam 240 extend toward an inner side of the conductive member 20 and are accommodated in the first groove 111 and the second groove 113, respectively. In some embodiments, the first free end of the first beam 220 and the second free end of the second beam 240 are opposite to each other in the width direction X. The length of the first beam 220 in the width direction may be smaller than the length of the first groove 111 in the width direction. The length of the second beam 240 in the width direction may be smaller than the length of the second groove 113 in the width direction.

In some embodiments, the size of the first beam 220 in the mating direction Y may be smaller than the size of the conductive member 20 in the mating direction Y. Optionally, the size of the first beam 220 in the mating direction Y is half the size of the conductive member 20 in the mating direction Y. In some embodiments, the stop portion (for example, beam) may bend toward the inner side of the conductive member 20 in the assembled state of the receptacle connector, to be engaged with the groove of the first portion. In some embodiments, the stop portion can be bendable and deformable. For example, the conductive member 20 may be made of metal. It should be understood that the number, the size, the location and the arrangement mode of the beam and the groove may not be limited to the specific embodiment shown, and may be configured according to specific applications.

The conductive member 20 may be at least partially attached to a mating side surface of the first portion 121. An inner contoured shape of the conductive member 20 is partially adapted to an external contour of the first portion 121. At least a portion of an inner circumferential surface of the conductive member 20 is closely fitted to an outer circumferential surface of the first portion 121.

In some embodiments, the terminal assembly 10 comprises a projection, the conductive member 20 comprises an opening 271, 291 for receiving the projection. An inner surface of the opening is at least partially in contact with the projection when the conductive member 20 is disposed to an outside portion of the assembly housing 120, so as to limit movement of the conductive member 20 in the mating direction of the receptacle connector 1.

In the assembled configuration of the receptacle connector of the present application, the stop portion of the conductive member 20 is engaged into the groove of the first portion of the terminal assembly, the projection of the terminal assembly 10 is engaged into the opening of the conductive member 20 so that a position of the conductive member 20 with respect to the assembly housing (e.g., an insulating rubber core) of the terminal assembly 10 is fixed. Such a configuration may reduce the risk that the conductive member shifts in the mating direction Y with respect to the terminal assembly. Such a configuration may reduce the risk that the first shell 30 and/or the second shell 40 connected to the conductive member 20 shift in the mating direction with respect to the terminal assembly 10. Such a configuration may reduce the risk of misalignment or undesired shifting of the conductive member 20 of the receptacle connector with respect to the terminal assembly 10 due to frequent plugging and unplugging of the mating portion of the plug connector. For example, such a configuration can reduce the risk that, when a user plugs the mating portion of the plug connector to the receptacle connector by a large force, the terminal assembly 10 (the insulating rubber core of the terminal assembly) is separated from the conductive member 20 and moves out from the distal side.

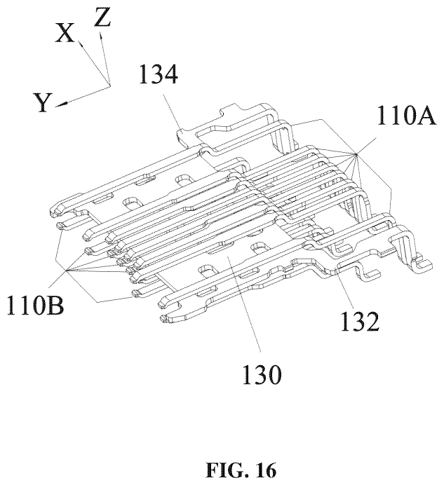

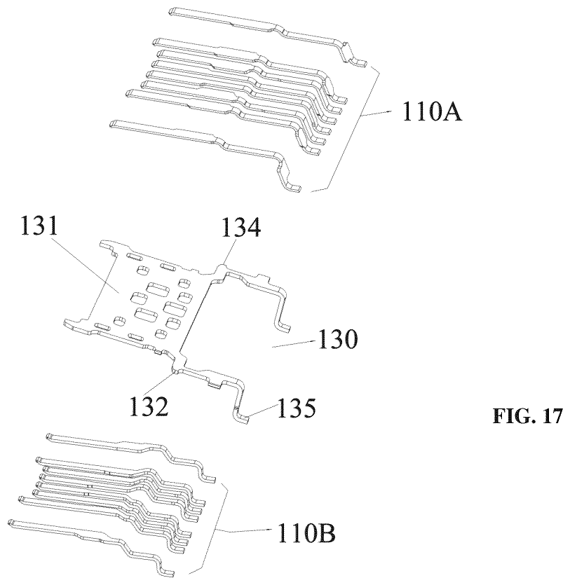

In some embodiments, each of the plurality of conductive elements 110 has an elongate strip shape and comprises a mating end and a tail provided opposite to the mating end. As shown in FIGS. 16-17, the plurality of conductive elements 110 comprise a first row of conductive elements 110A and a second row of conductive elements 110B. The first row of conductive elements 110A and the second row of conductive elements 110B are arranged in rows in a width direction X of the receptacle connector 1, respectively. The mating ends of a conductive elements of the first row of conductive elements 110A are spaced apart from, and aligned with, the mating end of the respective conductive elements of the second row of conductive elements 110B in a vertical direction Z of the receptacle connector. The terminal assembly 10 may further comprise a shielding member 130 disposed between the mating ends of the conductive element of the first row of conductive elements 110A and the mating ends of the conductive elements of the second row of conductive elements 110B in the vertical direction Z.

By providing a shielding member between the first row of conductive elements 110A and the second row of conductive elements 110B, the overall structural strength of the terminal assembly can be improved. Electromagnetic interference signals emitted by the conductive elements of one of the first row of conductive elements and the second row of conductive elements can be efficiently shielded with respect to the other one of the first row of conductive elements and the second row of conductive elements.

Referring to FIG. 10, in the illustrated example, the conductive member 20 comprises a third conducting sidewall 27 and a fourth conducting sidewall 29 being opposite to the third conducting sidewall 27 in a width direction X of the receptacle connector. Each of the third conducting sidewall 27 and the fourth conducting sidewall 29 extends along a plane perpendicular to the width direction X of the receptacle connector. The third conducting sidewall 27 comprises a first opening 271, and the fourth conducting sidewall 29 comprises a second opening 291.

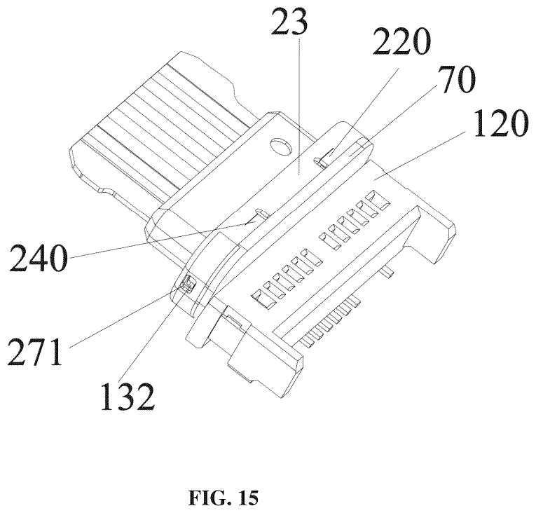

Referring to FIGS. 15-17, in the illustrated example, the shielding member 130 of the terminal assembly 10 comprises: a first projection 132 received in the first opening 271, and a second projection 134 received in the second opening 291. The first projection 132 and the second projection 134 are provided on opposite sides of the shielding member 130 in the width direction. Each of the first projection 132 and the second projection 134 extends from the shielding member 130 along the width direction X of the receptacle connector 1 toward an outside of the receptacle connector 1.

In some embodiments, the shielding member 130 may be made of a metallic material, and the shielding member 130 may achieve a shielding effect by reflecting, absorbing, or scattering electromagnetic waves, for example. Optionally, the shielding member 130 comprises an electrically conductive plastic shielding sheet or an insulating sheet coated with an electrically conductive metal material, or any suitable material capable of shielding the electromagnetic signal from interference.

In some embodiments, the shielding member 130 of the terminal assembly 10 may be electrically connected to the conductive member 20. The conductive member 20 is connected to the first shell 30. The first shell 30 is connected to the second shell 40. The second shell 40 is connected to the grounding portion of the circuit board of the electronic device, so that the shielding member 130 of the terminal assembly 10, the conductive member 20, the first shell 30, and the second shell 40 may together form a grounding loop to guide electromagnetic waves and interference signals generated in the receptacle connector and around the receptacle connector to the circuit board. Such a configuration may improve the grounding and shielding of the receptacle connector, thereby improving the stability of signal transmission.

As shown in FIG. 17, the shielding member 130 may comprise a plate-like shielding portion 131 and a grounding strip portion 135. The grounding strip portion 135 extends from the plate-like shielding portion 131 toward a distal side of the receptacle connector. The grounding strip portion 135 may be a grounding terminal connected to the circuit board. In some embodiments, the free end of the grounding strip portion 135 may be arranged in a row with the tail of the plurality of conductive elements of the first row of conductive elements 110A. The plate-like shielding portion 131 may efficiently shield electromagnetic interference between the first row of conductive elements 110A and the second row of conductive elements 110B. The grounding strip portion 135 may be connected to a grounding portion of the circuit board, thereby enhancing the shielding effect of the shielding member 130.

In some embodiments, a mating end of the first shell 30 extends beyond a mating end of the second shell 40 in a mating direction (mating direction Y) in which the receptacle connector 1 is connected to a corresponding plug connector. As shown in FIGS. 1 and 2, the receptacle connector 1 may comprise a first sealing member 60 attached to a portion of an outer sidewall of the first shell 30 that extends beyond a mating end of the second shell 40.

In some embodiments, as shown in FIG. 3, a roughen portion 32 is provided on a portion of an outer sidewall of the first shell 30 that extends beyond a mating end of the second shell 40. The first sealing member 60 is attached to the roughen portion 32 of the first shell 30. The roughen portion 32 comprises a pattern comprising at least one of a diagonal pattern, a grid pattern, or a predetermined symbol pattern. Optionally, the predetermined symbol pattern may comprise at least one of a starlike shape, a H shape, or an X shape. In some exemplary embodiments according to the present application, a surface roughness of the roughen portion 32 of the first shell 30 may be in the range of EDM 8-12.

The roughen portion 32 may be on a portion of an outer sidewall of the first shell that extends beyond the mating end of the second shell; and a first sealing member may be attached to the roughen portion of the first shell. With such a technical solution, a very close attachment between the first sealing member 60 and the first shell 30 can be provided, The outer sidewall of the first shell 30 of the receptacle connector provided with the roughen portion may have a surface roughness higher than a surface roughness of remaining portions of the first shell 30, thereby improving an adhesion force between the first sealing member 60 and the roughen portion 32 of the first shell 30. Such a configuration may reduce the risk that the first sealing member 60 falls off the first shell 30. When the receptacle connector 1 is mounted to the mounting portion of the electronic device, a seamless seal can be generated between the receptacle connector and the mounting portion of the electronic device, reducing the risk of water vapor/dust entering into the electronic device.

Optionally, the roughen portion 32 is on the outer sidewall of the first shell 30 and extends from the mating edge of the first shell 30 along the mating direction Y toward the distal side of the first shell. In some embodiments, the roughen portion 32 extends in the mating direction Y on the outer sidewall of the first shell 30 within a width range of 0.1 mm to 5 mm from the mating edge of the first shell 30. In some embodiments, the roughen portion 32 extends in the mating direction Y on the outer sidewall of the first shell 30 within a width range of 0.5 mm to 3 mm from the mating edge of the first shell 30. In some embodiments, the roughen portion 32 extends in the mating direction Y on the outer sidewall of the first shell 30 within a width range of 0.5 mm to 1.5 mm from the mating edge of the first shell 30.

In some embodiments, the first sealing member 60 is an elastically deformable member. The first sealing member 60 is configured to elastically deform when the first sealing member 60 contacts the mounting portion of the electronic device and to form an interference fit with a mounting portion of the electronic device in a direction perpendicular to the mating direction. In one example, the first sealing member 60 may be made of ultraviolet light-curable adhesive (UV adhesive), silicone, or epoxy resin adhesive. Ultraviolet light-curable adhesive is rapidly cured into an elastic adhesive film under UV light irradiation, and is characterized by high adhesive strength, vibration resistance, high temperature resistance, and good durability, etc. In some embodiments, the first sealing member 60 may extend in a range of 0.1 to 5 mm in the mating direction Y.

In some embodiments, the first sealing member 60 is configured to have an annular shape extending circumferentially and continuously around the mating end of the first shell 30. The first sealing member 60 is configured to have an attachment surface which forms a positive fit (a shape and position fitting) with a mating end of the first shell 30. It should be understood that the term “a positive fit (a shape and position fitting)” used in the present application may refer to a connection relationship in which two mating components are abutting and tightly fit with each other in terms of the shape and the position.

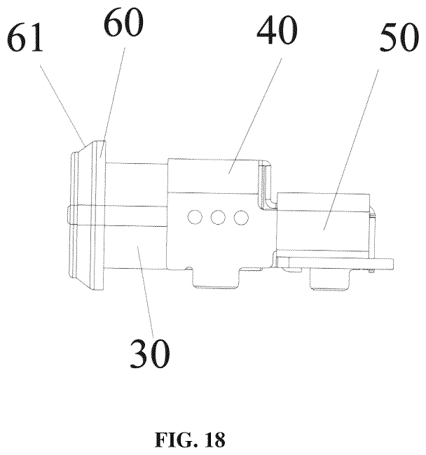

As shown in FIG. 18, the first sealing member 60 may comprise a tapering portion 61 tapering along the mating direction Y of the receptacle connector towards a mating end of the first sealing member 60. An oblique outer surface of the tapering portion 61 forms an angle of 20 degrees to 40 degrees relative to the surface of the mating end of the first sealing member 60.

In some embodiments, the assembly housing 120 may comprise a first portion 121 connected to the conductive member 20. The receptacle connector 1 may comprise a second sealing member 70 (FIG. 15) in a space bounded by the surface of the rear end of the first portion 121 and an inner surface of the first shell 30. An outer peripheral surface of the second sealing member 70 forms an interference fit with the inner surface of the first shell 30.

According to aspects of the present disclosure, a method of manufacturing a receptacle connector may comprise providing a terminal assembly 10 comprising a plurality of conductive elements 110 and an assembly housing 120 holding the plurality of conductive elements 110; providing a conductive member 20, and disposing the conductive member 20 on at least a portion of an outside portion of the assembly housing 120; providing a first shell 30, attaching the first shell 30 to the outside portion of the conductive member 20 and allowing the first shell 30 to surround at least a portion of the terminal assembly 10; and providing a second shell 40, and attaching the second shell 40 to the outside portion of the first shell 30.

The method may further comprise providing a third shell 50 having a mounting hole 51, and connecting the third shell fixedly to an outside portion of the second shell 40. In some embodiments, the method comprises: connecting the third shell 50 to the second shell 40 by welding. For example, the third shell 50 is connected to the second shell 40 by spot welding.

In some embodiments, the method comprises connecting the first shell 30 to the conductive member 20 by welding. For example, the first shell 30 is connected to the conductive member 20 by spot welding.

In some embodiments, providing the second shell 40 comprises: forming the second shell 40 as a profiled member, the second shell 40 comprising: a first portion 40A attached to the first shell 30, a second portion 40B attached to the assembly housing 120, and a transition portion connecting the first portion 40A and the second portion 40B. The method may comprise engaging a tab of the second portion 40B with a recess of the assembly housing 120 of the terminal assembly 10 for fixedly connecting the second shell 40 to the assembly housing 120. In some embodiments, the method comprises connecting the first portion 40A of the second shell 40 to the first shell 30 by welding.

In some embodiments, providing the terminal assembly 10 comprises: providing the assembly housing 120 comprising a first portion 121 connected to the conductive member 20 and disposed adjacent to a rear end of the first shell 30 and including a groove. Optionally, providing the conductive member 20 may comprise: providing the conductive member 20 comprising a stop portion engaged with the groove, the stop portion formed integrally with the conductive member 20.

In some embodiments, providing the terminal assembly 10 may comprise: providing the terminal assembly 10 comprising a projection. Providing the conductive member 20 may comprise: providing the conductive member 20 comprising an opening for receiving the projection. When the conductive member 20 is disposed on an outside portion of the assembly housing 120, an inner surface of the opening at least partially contacts the projection, so as to limit movement of the conductive member 20 in the mating direction Y of the receptacle connector 1.

In some embodiments, providing the terminal assembly 10 comprises: providing the plurality of conductive elements 110 comprising a first row of conductive elements 110A and a second row of conductive elements 110B; providing the first row of conductive elements 110A and the second row of conductive elements 110B arranged in rows in a width direction X of the receptacle connector 1, respectively; providing the mating ends of the conductive elements of the first row of conductive elements 110A spaced apart from, and aligned with, the mating ends of the respective conductive elements of the second row of conductive elements 110B in a vertical direction Z of the receptacle connector. The method may comprise: providing the terminal assembly 10 comprising a shielding member 130 disposed between the mating ends of the conductive elements of the first row of conductive elements 110A and the mating ends of the respective conductive elements of the second row of conductive elements 110B in the vertical direction Z; and forming projections on opposite sides of the shielding member 130 in the width direction X.

In some embodiments, providing the first shell 30 may comprise: roughening a portion of an outer sidewall of the first shell 30 near its mating end by laser engraving processing or electrical discharge processing to form a roughen portion 32. Optionally, the portion of an outer sidewall of the first shell 30 near its mating end is embossed or knurled to form the roughen portion 32.

In some embodiments, the method may further comprise: applying a first adhesive along a circumferential direction of the first shell 30 at a portion of an outer sidewall of the first shell 30 extending beyond a mating end of the second shell 40, and curing the first adhesive to form a first sealing member 60 attached to the outer sidewall of the first shell 30.

The method may comprise: providing a tool configured to shape the first sealing member 60 in terms of a predetermined size and shape; placing a roughen portion 32 of the mating end of the first shell 30 to be processed in the tool, and applying a first adhesive at the roughen portion in a circumferential direction along the first shell. The first adhesive is applied in the tool by one of the following: time and pressure type dispensing, piston pump dispensing, and screw metering pump dispensing.

In some embodiments, an adhesive is received in the tool. The adhesive may be selected from one of the following: UV adhesive, silicone, epoxy resin adhesive. In some embodiments, the adhesive may be underfill.

In some embodiments, the method comprises: after connecting the first shell 30 to the conductive member 20 by welding, applying a second adhesive in a space bounded by a surface of a rear end of the first portion 121 and an inner surface of the first shell 30, and curing the second adhesive to form a second sealing member 70. An outer peripheral surface of the second sealing member 70 is configured to form an interference fit with an inner surface of the first shell 30.

Such a configuration may enable that the second sealing member 70 fill a gap between the surface of the rear end of the first portion 121 and the inner surface of the first shell 30, reducing the risk that moisture enters the receptacle connector through the gap between the first shell and the terminal assembly. A seamless sealing effect may be obtained. The requirements of the waterproof rating for the receptacle connector are met, and the life of the receptacle connector may be enhanced.

Various aspects are described in this disclosure, which include, but are not limited to, the following aspects:

1. A receptacle connector (e.g., 1) comprising: a terminal assembly (e.g., 10) comprising a plurality of conductive elements (e.g., 110) and an assembly housing (e.g., 120) holding the plurality of conductive elements (e.g., 110); a conductive member (e.g., 20) disposed to at least a portion of an outside portion of the assembly housing (e.g., 120); a first shell (e.g., 30) disposed to an outside portion of the conductive member (e.g., 20) and attached to the conductive member (e.g., 20), and the first shell (e.g., 30) enclosing at least a portion of the terminal assembly (e.g., 10); and a second shell (e.g., 40) attached to an outside portion of the first shell (e.g., 30), wherein the receptacle connector (e.g., 1) further comprises a third shell (e.g., 50) fixedly attached to an outside portion of the second shell (e.g., 40), and the third shell (e.g., 50) comprises a mounting hole (e.g., 51).

2. The receptacle connector according to aspect 1, wherein the third shell (e.g., 50) comprises: a horizontal portion (e.g., 501) connected to the second shell (e.g., 40); and a first mounting portion (e.g., 502) and a second mounting portion (e.g., 504) provided in a width direction (e.g., X) of the receptacle connector (e.g., 1) on opposite sides of the horizontal portion (e.g., 501), each of the first mounting portion (e.g., 502) and the second mounting portion (e.g., 504) extends beyond the second shell (e.g., 40) from the horizontal portion (e.g., 501) along the width direction (e.g., X), and the mounting hole (e.g., 51) is provided at each of the first mounting portion (e.g., 502) and the second mounting portion (e.g., 504).

3. The receptacle connector according to aspect 2, wherein the horizontal portion (e.g., 501) of the third shell (e.g., 50) is configured to extend in a plane perpendicular to a vertical direction (e.g., Z) of the receptacle connector (e.g., 1), the third shell (e.g., 50) comprises a first vertical portion (e.g., 503) connecting the horizontal portion (e.g., 501) to the first mounting portion (e.g., 502), and a second vertical portion (e.g., 505) connecting the horizontal portion (e.g., 501) to the second mounting portion (e.g., 504), each of the first vertical portion (e.g., 503) and the second vertical portion (e.g., 505) extends in a manner substantially perpendicular to the horizontal portion (e.g., 501).

4. The receptacle connector according to aspect 1, wherein the third shell (e.g., 50) is connected to the second shell (e.g., 40) by welding, and a third joining portion joins the third shell (e.g., 50) and the second shell (e.g., 40).

5. The receptacle connector according to aspect 4, wherein the third shell (e.g., 50) is connected to the second shell (e.g., 40) by spot welding, and the third joining portion comprises one or more groups of third joining points joining the third shell (e.g., 50) and the second shell (e.g., 40).

6. The receptacle connector according to aspect 5, wherein each group of joining points is arranged in a linear array, an L-shaped array, or a curved array.

7. The receptacle connector according to aspect 5, wherein the third joining portion comprises a first group of third joining points (e.g., S11) and a second group of third joining points (e.g., S13), and the first group of third joining points (e.g., S11) and the second group of third joining points (e.g., S13) are provided to be symmetrical about a axis (e.g., A-A) of the receptacle connector.

8. The receptacle connector according to any one of aspects 1 to 7, wherein the first shell (e.g., 30) is connected to the conductive member (e.g., 20) by welding, and a first joining portion joins the first shell (e.g., 30) and the conductive member (e.g., 20).

9. The receptacle connector according to aspect 8, wherein the first shell (e.g., 30) is connected to the conductive member (e.g., 20) by spot welding, and the first joining portion comprises one or more groups of first joining points joining the first shell (e.g., 30) and the conductive member (e.g., 20).

10. The receptacle connector according to aspect 9, wherein the first shell (e.g., 30) has a substantially cylindrical shape and comprises: a first sidewall (e.g., 301) and a second sidewall (e.g., 303) opposite to each other in a vertical direction (e.g., Z) of the receptacle connector; and a third sidewall (e.g., 305) and a fourth sidewall (e.g., 307) opposite to each other in a width direction (e.g., X) of the receptacle connector, wherein each of the third sidewall (e.g., 305) and the fourth sidewall (e.g., 307) is connected to the first sidewall (e.g., 301) and the second sidewall (e.g., 303); the first joining portion comprises a first group of first joining points (e.g., S21) and a second group of first joining points (e.g., S22), the first group of first joining points (e.g., S21) is in a portion of the first sidewall (e.g., 301) of the first shell (e.g., 30) that is adjacent to a rear end of the first shell (e.g., 30), the second group of first joining points (e.g., S22) is in a portion of the second sidewall (e.g., 303) of the first shell (e.g., 30) that is adjacent to the rear end of the first shell (e.g., 30), and each of the first group of first joining points (e.g., S21) and the second group of first joining points (e.g., S22) is arranged in a linear array in the width direction (e.g., X) of the receptacle connector.

11. The receptacle connector according to any one of aspects 1 to 7, wherein the second shell (e.g., 40) is a profiled member and comprises: a first portion (e.g., 40A) attached to the first shell (e.g., 30), a second portion (e.g., 40B) attached to the assembly housing (e.g., 120), and a transition portion (e.g., 40C) connecting the first portion (e.g., 40A) and the second portion (e.g., 40B), wherein the second portion (e.g., 40B) comprises a tab, and the assembly housing (e.g., 120) of the terminal assembly (e.g., 10) comprises a recess for receiving the tab, and the tab is engaged with the recess for fixedly connecting the second shell (e.g., 40) to the assembly housing (e.g., 120).

12. The receptacle connector according to aspect 11, wherein the first shell (e.g., 30) has a substantially cylindrical shape and comprises: a first sidewall (e.g., 301) and a second sidewall (e.g., 303) opposite to each other in a vertical direction (e.g., Z) of the receptacle connector; and a third sidewall (e.g., 305) and a fourth sidewall (e.g., 307) opposite to each other in a width direction (e.g., X) of the receptacle connector, wherein each of the third sidewall (e.g., 305) and the fourth sidewall (e.g., 307) is connected to the first sidewall (e.g., 301) and the second sidewall (e.g., 303); the first portion (e.g., 40A) of the second shell (e.g., 40) comprises a first top wall (e.g., 401) connected to the first sidewall (e.g., 301) of the first shell (e.g., 30), a first side wall (e.g., 402) connected to the first top wall and substantially perpendicular to the first top wall, and a second side wall (e.g., 404) opposite to the first side wall (e.g., 402) in the width direction (e.g., X) of the receptacle connector and connected to the first top wall, wherein each of the first side wall (e.g., 402) and the second side wall (e.g., 404) extends in a plane perpendicular to the width direction of the receptacle connector, and a bottom end of each of the first side wall (e.g., 402) and the second side wall (e.g., 404) extends beyond the first shell (e.g., 30) in the vertical direction (e.g., Z) of the receptacle connector, and the second portion (e.g., 40B) of the second shell (e.g., 40) comprises: a second top wall (e.g., 403) corresponding to an outer surface of the assembly housing (e.g., 120) provided on the same side as the first sidewall (e.g., 301) of the first shell (e.g., 30); a third side wall (e.g., 406) connected to the second top wall and substantially perpendicular to the second top wall; and a fourth side wall (e.g., 408) opposite to the third side wall (e.g., 406) in a width direction (e.g., X) of the receptacle connector and connected to the second top wall, wherein each of the third side wall (e.g., 406) and the fourth side wall (e.g., 408) extends in a plane perpendicular to the width direction of the receptacle connector, and a bottom end of each of the third side wall (e.g., 406) and the fourth side wall (e.g., 408) extends beyond the assembly housing (e.g., 120) in the vertical direction (e.g., Z) of the receptacle connector.

13. The receptacle connector according to aspect 12, wherein the tab comprises a first tab (e.g., 45) and a second tab (e.g., 47), the first tab (e.g., 45) extends from the bottom end of the third side wall (e.g., 406) and is a sheet-like portion that is substantially perpendicular to the third side wall (e.g., 406) and extends from the third side wall (e.g., 406) toward the longitudinal central axis (e.g., A-A) of the receptacle connector, and the second tab (e.g., 47) extends from the bottom end of the fourth side wall (e.g., 408) and is a sheet-like portion that is substantially perpendicular to the fourth side wall (e.g., 408) and extends from the fourth side wall (e.g., 408) toward the longitudinal central axis (e.g., A-A) of the receptacle connector, the recess is on an outer surface of the assembly housing (e.g., 120) provided on the same side as the second sidewall (e.g., 303) of the first shell (e.g., 30), and is provided at an edge adjacent to the third side wall (e.g., 406) and the fourth side wall (e.g., 408), and the recess comprises a first recess (e.g., 105) engaged with the first tab (e.g., 45) and a second recess (e.g., 107) engaged with the second tab (e.g., 47).

14. The receptacle connector according to aspect 12, wherein the first portion (e.g., 40A) of the second shell (e.g., 40) is connected to the first shell (e.g., 30) by welding, and a second joining portion joins the first portion (e.g., 40A) of the second shell (e.g., 40) and the first shell (e.g., 30).

15. The receptacle connector according to aspect 14, wherein the first portion (e.g., 40A) of the second shell (e.g., 40) is connected to the first shell (e.g., 30) by spot welding, and the second joining portion comprises a second joining point joining the first portion (e.g., 40A) of the second shell (e.g., 40) and the first shell (e.g., 30).

16. The receptacle connector according to aspect 15, wherein the second joining portion comprises a first group of second joining points (e.g., S31) and a second group of second joining points (e.g., S32), the first portion (e.g., 40A) of the second shell (e.g., 40) is connected to the first sidewall (e.g., 301) of the first shell (e.g., 30) by the first group of second joining points (e.g., S31) and the second group of second joining points (e.g., S32), and each of the first group of second joining points (e.g., S31) and the second group of second joining points (e.g., S32) is arranged in an L-shaped or linear array.

17. The receptacle connector according to aspect 16, wherein the second joining portion further comprises: a third group of second joining points (e.g., S33) for connecting the first side wall (e.g., 402) of the second shell (e.g., 40) to the third sidewall (e.g., 305) of the first shell (e.g., 30); a fourth group of second joining points (e.g., S34) for connecting the second side wall (e.g., 404) of the second shell (e.g., 40) to the fourth sidewall (e.g., 307) of the first shell (e.g., 30), and each of the third group of second joining points (e.g., S33) and the fourth group of second joining points (e.g., S34) is arranged in a linear array in the mating direction (e.g., Y) of the receptacle connector.

18. The receptacle connector according to any one of aspects 1 to 7, wherein the assembly housing (e.g., 120) comprises a first portion (e.g., 121) connected to the conductive member (e.g., 20), the first portion (e.g., 121) is disposed adjacent to a rear end of the first shell (e.g., 30) and comprises a groove, and the conductive member (e.g., 20) comprises a stop portion engaged with the groove.

19. The receptacle connector according to aspect 18, wherein the conductive member (e.g., 20) comprises a plurality of stop portions extending from a top wall (e.g., 23) and/or on a bottom wall (e.g., 25) of the conductive member (e.g., 20), and the top wall (e.g., 23) is opposite to the bottom wall (e.g., 25) in a vertical direction (e.g., Z) of the receptacle connector.

20. The receptacle connector according to aspect 19, wherein the stop portion is a beam comprising a first beam (e.g., 220) and a second beam (e.g., 240) extending from the top wall (e.g., 23) of the conductive member (e.g., 20), the first portion (e.g., 121) comprises a first groove (e.g., 111) that cooperates with the first beam (e.g., 220) and a second groove (e.g., 113) that cooperates with the second beam (e.g., 240), and the first groove (e.g., 111) and the second groove (e.g., 113) are open toward the conductive member (e.g., 20) in a vertical direction (e.g., Z) of the receptacle connector.

21. The receptacle connector according to aspect 20, wherein the beam comprises a third beam (e.g., 260) and a fourth beam (e.g., 280) extending from the bottom wall (e.g., 25) of the conductive member (e.g., 20), the first portion (e.g., 121) comprises a third groove (e.g., 115) that cooperates with the third beam (e.g., 260) and a fourth groove (e.g., 117) that cooperates with the fourth beam (e.g., 280), and the third groove (e.g., 113) and the fourth groove (e.g., 117) are open toward the conductive member (e.g., 20) in a vertical direction (e.g., Z) of the receptacle connector.

22. The receptacle connector according to any one of aspects 1 to 7, wherein the terminal assembly (e.g., 10) comprises a projection, the conductive member (e.g., 20) comprises an opening for receiving the projection, and an inner surface of the opening is at least partially in contact with the projection when the conductive member (e.g., 20) is disposed to the outside portion of the assembly housing (e.g., 120), so as to limit movement of the conductive member (e.g., 20) in the mating direction of the receptacle connector (e.g., 1).

23. The receptacle connector according to aspect 22, wherein each of the plurality of conductive elements (e.g., 110) has an elongate strip shape and comprises a mating end and a tail positioned opposite to the mating end, the plurality of conductive elements (e.g., 110) comprises a first row of conductive elements (e.g., 110A) and a second row of conductive elements (e.g., 110B), and the first row of conductive elements (e.g., 110A) and the second row of conductive elements (e.g., 110B) are arranged in rows in a width direction (e.g., X) of the receptacle connector (e.g., 1), respectively, the mating ends of the conductive elements of the first row of conductive elements (e.g., 110A) are spaced apart from, and aligned with, the mating ends of the respective conductive elements of the second row of conductive elements (e.g., 110B) in a vertical direction (e.g., Z) of the receptacle connector, and the terminal assembly (e.g., 10) further comprises a shielding member (e.g., 130) disposed between the mating ends of the conductive elements of the first row of conductive elements (e.g., 110A) and the mating ends of the conductive elements of the second row of conductive elements (e.g., 110B) in the vertical direction (e.g., Z).

24. The receptacle connector according to aspect 23, wherein the conductive member (e.g., 20) comprises a third conducting sidewall (e.g., 27) and a fourth conducting sidewall (e.g., 29) opposite to the third conducting sidewall (e.g., 27) in a width direction (e.g., X) of the receptacle connector, and each of the third conducting sidewall (e.g., 27) and the fourth conducting sidewall (e.g., 29) extends along a plane perpendicular to the width direction (e.g., X) of the receptacle connector, the third conducting sidewall (e.g., 27) comprises a first opening (e.g., 271), and the fourth conducting sidewall (e.g., 29) comprises a second opening (e.g., 291); and the shielding member (e.g., 130) of the terminal assembly (e.g., 10) comprises: a first projection (e.g., 132) received in the first opening (e.g., 271), and a second projection (e.g., 134) received in the second opening (e.g., 291), the first projection (e.g., 132) and the second projection (e.g., 134) are provided on opposite sides of the shielding member (e.g., 130) in the width direction, and each of the first projection (e.g., 132) and the second projection (e.g., 134) extends from the shielding member (e.g., 130) along the width direction (e.g., X) of the receptacle connector (e.g., 1) toward an outside of the receptacle connector (e.g., 1).

25. The receptacle connector according to any one of aspects 1 to 7, wherein a mating end of the first shell (e.g., 30) extends beyond a mating end of the second shell (e.g., 40) in a mating direction in which the receptacle connector is connected to a corresponding plug connector; the receptacle connector comprises a first sealing member (e.g., 60) attached to a portion of an outer sidewall of the first shell (e.g., 30) that extends beyond a mating end of the second shell (e.g., 40).

26. The receptacle connector according to aspect 25, wherein a roughen portion (e.g., 32) is provided on a portion of the outer sidewall of the first shell (e.g., 30) that extends beyond the mating end of the second shell (e.g., 40), the first sealing member (e.g., 60) is attached to the roughen portion (e.g., 32) of the first shell (e.g., 30), and the roughen portion (e.g., 32) comprises a pattern comprising at least one of a diagonal pattern, a grid pattern, or a predetermined symbol pattern.

27. The receptacle connector according to aspect 26, wherein the predetermined symbol pattern comprises at least one of a starlike shape, a H shape, or an X shape.

28. The receptacle connector according to aspect 26, wherein a width of the roughen portion (e.g., 32) in the mating direction (e.g., Y) of the receptacle connector extends in a range of 0.1 mm to 5 mm.

29. The receptacle connector according to aspect 25, wherein the first sealing member (e.g., 60) is an elastically deformable member and the first sealing member (e.g., 60) is configured to elastically deform when the first sealing member (e.g., 60) contacts with a mounting portion of an electronic device and to form an interference fit with the mounting portion of the electronic device in a direction perpendicular to the mating direction.

30. The receptacle connector according to aspect 25, wherein the first sealing member (e.g., 60) is configured to have an annular shape extending circumferentially and continuously around the mating end of the first shell (e.g., 30), and the first sealing member (e.g., 60) is configured to have an attachment surface which forms a positive fit with the mating end of the first shell (e.g., 30).

31. The receptacle connector according to aspect 25, wherein the first sealing member (e.g., 60) comprises a tapering portion (e.g., 61) tapering along a mating direction of the receptacle connector towards a mating end of the first sealing member (e.g., 60), and an oblique outer surface of the tapering portion (e.g., 61) forms an angle of 20 degrees to 40 degrees relative to a surface of the mating end of the first sealing member (e.g., 60).

32. The receptacle connector according to any one of aspects 1 to 7, wherein the assembly housing (e.g., 120) comprises a first portion (e.g., 121) connected to the conductive member (e.g., 20), the receptacle connector (e.g., 1) comprises a second sealing member (e.g., 70) provided in a space bounded by a surface of a rear end of the first portion (e.g., 121) and an inner surface of the first shell (e.g., 30), and an outer peripheral surface of the second sealing member (e.g., 70) forms an interference fit with the inner surface of the first shell (e.g., 30).

33. A receptacle connector (e.g., 1) configured for mounting to a substrate and extending in a vertical direction (e.g., Z) above the substrate, comprising: a terminal assembly (e.g., 10) comprising: a plurality of conductive elements (e.g., 110), each of the plurality of conductive elements comprising a mating end (e.g., 550), a tail (e.g., 552), and an intermediate portion between the mating end and the tail, a housing (e.g., 120) comprising a tongue (e.g., 250) holding the mating ends of the plurality of conductive elements, a rear portion (e.g., 252), and a first portion (e.g., 121) between the tongue and the rear portion, top surfaces of the tongue, rear portion, and first portion offset from each other in the vertical direction, and a shielding member (e.g., 130) held by the housing and comprising one or more projections extending out of the first portion of the housing; a conductive member (e.g., 20) disposed on the first portion of the housing of the terminal assembly, the conductive member comprising one or more openings (e.g., 271, 291) configured for receiving the one or more projections (e.g., 132, 134) of the shielding member; and a first shell (e.g., 30) surrounding the terminal assembly from the tongue to the first portion of the housing of the terminal assembly and connected to the conductive member at a first joining portion.

34. A receptacle connector (e.g., 1) comprising: a terminal assembly (e.g., 10) comprising a plurality of conductive elements (e.g., 110), each of the plurality of conductive elements comprising a mating end, a tail, and an intermediate portion between the mating end and the tail, and a housing (e.g., 120) comprising a tongue holding the mating ends of the plurality of conductive elements, a rear portion, and a first portion (e.g., 121) between the tongue and the rear portion, top surfaces of the tongue, rear portion, and first portion offset from each other in a vertical direction; a conductive member (e.g., 20) disposed on the first portion of the housing of the terminal assembly; a first shell (e.g., 30) surrounding the terminal assembly from the tongue to the first portion of the housing of the terminal assembly and connected to the conductive member at a first joining portion; a second shell (e.g., 40) comprising a first portion (e.g., 40A) disposed on a rear portion of the first shell and connected to the rear portion of the first shell at a second joining portion, a second portion (e.g., 40B) disposed on the rear portion of the housing of the terminal assembly, and a transition portion (e.g., 40C) connecting the first portion and the second portion; and a third shell (e.g., 50) comprising a horizontal portion disposed on and connected to the second portion of the second shell at a third joining portion, and first and second mounting portions disposed on opposite sides of the horizontal portion, each of the first and second mounting portions comprising a threaded hole.

35. The receptacle connector of aspect 34, wherein the terminal assembly comprises a shielding member held by the housing and comprising one or more projections extending out of the first portion of the housing.

36. The receptacle connector of aspect 33 or aspect 35, wherein the first joining portion comprising a plurality of first joining points (e.g., S21, S22).

37. The receptacle connector of aspect 36, wherein the plurality of first joining points are arranged in a linear array.

38. The receptacle connector of aspect 33 or aspect 34, wherein the first shell is electrically coupled to the shielding member of the terminal assembly via the conductive member.

39. The receptacle connector of aspect 33, comprising: a second shell comprising: a first portion disposed on a rear portion of the first shell and connected to the rear portion of the first shell at a second joining portion, a second portion disposed on the rear portion of the housing of the terminal assembly, and a transition portion connecting the first portion and the second portion.

40. The receptacle connector of aspect 35 or aspect 39, wherein the second joining portion comprises a plurality of second joining points (e.g., S31, S32, S33).

41. The receptacle connector of aspect 40, wherein the plurality of second joining points comprise two symmetrical groups.

42. The receptacle connector of aspect 41, wherein the second joining points in each of the two symmetrical groups is arranged in an L-shaped array.

43. The receptacle connector of aspect 41, wherein the first portion of the second shell comprises: a first top wall connected to the first shell at the two symmetrical groups of the plurality of second joining points, and first and second side walls connected to the first shell at second joining points of the plurality of second joining points, the first and second side walls comprising mounting tails extending beyond a bottom of the first shell.

44. The receptacle connector of aspect 43, wherein the second portion of the second shell comprises: a second top wall disposed on a top surface of the rear portion of the housing of the terminal assembly, third and fourth side walls extending from the second top wall and aligned with the first and second side walls of the first portion of the second shell, respectively, the third and fourth side walls comprising mounting tails extending beyond a bottom of the rear portion of the housing of the terminal assembly, and a rear wall disposed on a rear surface of the rear portion of the housing of the terminal assembly and connecting the third and fourth side walls.

45. The receptacle connector of aspect 35 or aspect 39, wherein the second shell is electrically coupled to the shielding member of the terminal assembly via the conductive member and the first shell.

46. The receptacle connector of aspect 39, comprising a third shell comprising a horizontal portion disposed on and connected to the second portion of the second shell at a third joining portion.

47. The receptacle connector of aspect 35 or aspect 46, wherein the third joining portion comprises a plurality of third joining points (e.g., S11, S13).

48. The receptacle connector of aspect 47, wherein the plurality of third joining points comprise two symmetrical groups.

49. The receptacle connector of aspect 46, wherein the third shell comprises first and second mounting portions disposed on opposite sides of the horizontal portion, each of the first and second mounting portions comprising a threaded hole.

50. The receptacle connector of aspect 35 or aspect 46, wherein the third shell is electrically coupled to the shielding member of the terminal assembly via the conductive member and the first and second shells.

51. The receptacle connector of aspect 35 or aspect 39, comprising a rear sealing member (e.g., 70) disposed in a gap between the first portion of the housing of the terminal assembly and the transition portion of the second shell.

52. The receptacle connector of aspect 51, comprising a front sealing member (e.g., 60) disposed on a rough portion of a mating end of the first shell.

53. A method of manufacturing a receptacle connector (e.g., 1), comprising: providing a terminal assembly (e.g., 10) comprising a plurality of conductive elements (e.g., 110), each of the plurality of conductive elements comprising a mating end, a tail, and an intermediate portion between the mating end and the tail, and a housing (e.g., 120) comprising a tongue holding the mating ends of the plurality of conductive elements, a rear portion, and a first portion between the tongue and the rear portion; disposing a conductive member (e.g., 20) on the first portion of the housing of the terminal assembly; inserting the terminal assembly into a shell until the conductive member abuts a rear end of the shell; welding the shell (e.g., 30) to the conductive member to form a joining portion; and after the welding, filling an adhesive for forming a sealing member (e.g., 70) in a gap between the first portion (e.g., 121) and rear portion (e.g., 252) of the housing of the terminal assembly.

54. The method of aspect 53, wherein: the shell is a first shell; the joining portion is a first joining portion; and the method further comprises: after filling the adhesive for the sealing member, disposing a first portion of a second shell (e.g., 40) on a rear portion of the first shell and a second portion of the second shell on the rear portion of the housing of the terminal assembly, and welding the first portion of the second shell to the first shell to form a second joining portion.

55. The method of aspect 54, further comprising: disposing a third shell (e.g., 50) on the second portion of the second shell; and welding the third shell to the second portion of the second shell to form a third joining portion.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to right angle connectors. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front’, “rear”, “upper”, “lower”, “left”, “right”, “transverse direction”, “vertical direction”, “perpendicular”, “horizontal”, “top”, “bottom” and the like are shown based on the accompanying drawings, for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. A receptacle connector configured for mounting to a substrate and extending in a vertical direction above the substrate, comprising:
a terminal assembly comprising:
a plurality of conductive elements, each of the plurality of conductive elements comprising a mating end, a tail, and an intermediate portion between the mating end and the tail,
a housing comprising a tongue holding the mating ends of the plurality of conductive elements, a rear portion, and a first portion between the tongue and the rear portion, top surfaces of the tongue, rear portion, and first portion offset from each other in the vertical direction, and
a shielding member held by the housing and comprising one or more projections extending out of the first portion of the housing;
a conductive member disposed on the first portion of the housing of the terminal assembly, the conductive member comprising one or more openings configured for receiving the one or more projections of the shielding member; and
a first shell surrounding the terminal assembly from the tongue to the first portion of the housing of the terminal assembly and connected to the conductive member at a first joining portion.

2. The receptacle connector of claim 1, wherein:
the first joining portion comprising a plurality of first joining points.

3. The receptacle connector of claim 2, wherein:
the plurality of first joining points are arranged in a linear array.

4. The receptacle connector of claim 1, wherein:
the first shell is electrically coupled to the shielding member of the terminal assembly via the conductive member.

5. The receptacle connector of claim 1, comprising:
a second shell comprising:
a first portion disposed on a rear portion of the first shell and connected to the rear portion of the first shell at a second joining portion,
a second portion disposed on the rear portion of the housing of the terminal assembly, and
a transition portion connecting the first portion and the second portion.

6. The receptacle connector of claim 5, wherein:
the second joining portion comprises a plurality of second joining points.

7. The receptacle connector of claim 6, wherein:
the plurality of second joining points comprise two symmetrical groups.

8. The receptacle connector of claim 7, wherein:
the second joining points in each of the two symmetrical groups is arranged in an L-shaped array.

9. The receptacle connector of claim 7, wherein the first portion of the second shell comprises:
a first top wall connected to the first shell at the two symmetrical groups of the plurality of second joining points, and
first and second side walls connected to the first shell at second joining points of the plurality of second joining points, the first and second side walls comprising mounting tails extending beyond a bottom of the first shell.

10. The receptacle connector of claim 9, wherein the second portion of the second shell comprises:
a second top wall disposed on a top surface of the rear portion of the housing of the terminal assembly,
third and fourth side walls extending from the second top wall and aligned with the first and second side walls of the first portion of the second shell, respectively, the third and fourth side walls comprising mounting tails extending beyond a bottom of the rear portion of the housing of the terminal assembly, and
a rear wall disposed on a rear surface of the rear portion of the housing of the terminal assembly and connecting the third and fourth side walls.

11. The receptacle connector of claim 5, wherein:
the second shell is electrically coupled to the shielding member of the terminal assembly via the conductive member and the first shell.

12. The receptacle connector of claim 5, comprising:
a third shell comprising a horizontal portion disposed on and connected to the second portion of the second shell at a third joining portion.

13. The receptacle connector of claim 12, wherein:
the third joining portion comprises a plurality of third joining points.

14. The receptacle connector of claim 13, wherein:
the plurality of third joining points comprise two symmetrical groups.

15. The receptacle connector of claim 12, wherein:
the third shell comprises first and second mounting portions disposed on opposite sides of the horizontal portion, each of the first and second mounting portions comprising a threaded hole.

16. The receptacle connector of claim 12, wherein:
the third shell is electrically coupled to the shielding member of the terminal assembly via the conductive member and the first and second shells.

17. The receptacle connector of claim 5, comprising:
a rear sealing member disposed in a gap between the first portion of the housing of the terminal assembly and the transition portion of the second shell.

18. The receptacle connector of claim 17, comprising:
a front sealing member disposed on a rough portion of a mating end of the first shell.

19. A receptacle connector comprising:
a terminal assembly comprising a plurality of conductive elements, each of the plurality of conductive elements comprising a mating end, a tail, and an intermediate portion between the mating end and the tail, and a housing comprising a tongue holding the mating ends of the plurality of conductive elements, a rear portion, and a first portion between the tongue and the rear portion, top surfaces of the tongue, rear portion, and first portion offset from each other in a vertical direction;
a conductive member disposed on the first portion of the housing of the terminal assembly;
a first shell surrounding the terminal assembly from the tongue to the first portion of the housing of the terminal assembly and connected to the conductive member at a first joining portion;
a second shell comprising a first portion disposed on a rear portion of the first shell and connected to the rear portion of the first shell at a second joining portion, a second portion disposed on the rear portion of the housing of the terminal assembly, and a transition portion connecting the first portion and the second portion; and
a third shell comprising a horizontal portion disposed on and connected to the second portion of the second shell at a third joining portion, and first and second mounting portions disposed on opposite sides of the horizontal portion, each of the first and second mounting portions comprising a threaded hole.

20. A method of manufacturing a receptacle connector, comprising:
providing a terminal assembly comprising a plurality of conductive elements, each of the plurality of conductive elements comprising a mating end, a tail, and an intermediate portion between the mating end and the tail, and a housing comprising a tongue holding the mating ends of the plurality of conductive elements, a rear portion, and a first portion between the tongue and the rear portion;
disposing a conductive member on the first portion of the housing of the terminal assembly;
inserting the terminal assembly into a shell until the conductive member abuts a rear end of the shell;
welding the shell to the conductive member to form a joining portion; and
after the welding, filling an adhesive for forming a sealing member in a gap between the first portion and rear portion of the housing of the terminal assembly.
